(19) United States
(12) Patent Application Publication
(10) Pub. No.: US 2017/0337833 A1
(43) Pub. Date: Nov. 23, 2017

(54) EDUCATION SUPPORT SYSTEM

(71) Applicant: KYOCERA Corporation, Kyoto-shi (JP)

(72) Inventors: Atsuhiko KANDA, Yokohama-shi (JP); Takayuki YAJIMA, Miura-gun (JP); Tomoaki MIWA, Fujisawa-shi (JP); Katsuaki OONISHI, Setagaya-ku (JP)

(21) Appl. No.: 15/597,119

(22) Filed: May 16, 2017

(30) Foreign Application Priority Data
May 17, 2016 (JP) 2016-099045

(51) Int. Cl. G09B 5/02; G06F 3/147; G09B 7/00; G06F 3/041; G06F 3/16

(52) U.S. Cl. CPC G09B 5/02; G09B 7/00; G06F 3/041; G06F 3/147; G06F 3/16

(57) ABSTRACT

An education support system includes a mobile device that is attached to an object and is configured to detect an action of the object, and an analyzer that has information on an activity schedule including a learning schedule of the object. The analyzer is configured to calculate an activity amount for each activity schedule based on an action of the object detected by the mobile device and determine a state of the object based on the activity amount for each activity schedule.

### CROSS-REFERENCE TO RELATED APPLICATION(S)

The present application claims priority to and incorporates by reference the entire contents of Japanese Patent Application No. 2016-099045 filed in Japan on May 17, 2016.

### BACKGROUND

### 1. Field

The present disclosure relates to an education support system.

### 2. Description of the Related Art

There has been known a mobile electronic device that has a function of acquiring and managing information using a plurality of sensors.

### SUMMARY

In one embodiment, an education support system includes a mobile device that is attached to an object and is configured to detect an action of the object, and an analyzer that has information on an activity schedule including a learning schedule of the object. The analyzer is configured to calculate an activity amount for each activity schedule based on an action of the object detected by the mobile device and determine a state of the object based on the activity amount for each activity schedule.

### BRIEF DESCRIPTION OF THE DRAWINGS

FIG. 1 is a view illustrating a schematic configuration of an education support system;

FIG. 2 is a block diagram illustrating a functional configuration of a mobile device;

FIG. 3 is a block diagram illustrating a functional configuration of a tablet;

FIG. 4 is a block diagram illustrating a functional configuration of an analyzer;

FIG. 5 is a flowchart illustrating an example of operation of the analyzer;

FIG. 6 is a flowchart illustrating an example of operation of the analyzer;

FIG. 7 is a flowchart illustrating an example of operation of the analyzer;

FIG. 8 is an example of a screen displayed on a tablet for a manager;

FIG. 9 is an example of a screen displayed on the tablet for a manager;

FIG. 10 is an example of a screen displayed on the tablet for a manager;

FIG. 11 is an example of a screen displayed on the tablet for a manager;

FIG. 12 is an example of a screen displayed on the tablet for a manager; and

FIG. 13 is an example of a screen displayed on the tablet for a manager.

### DETAILED DESCRIPTION

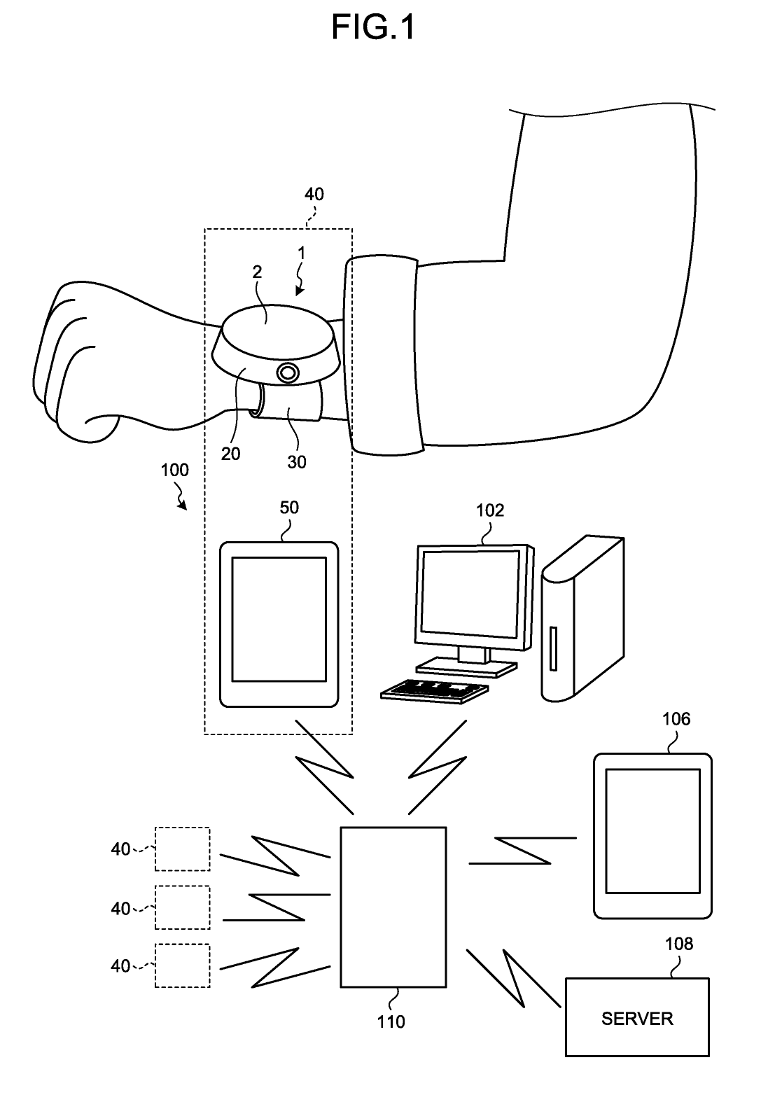

The mobile electronic device can detect information on a user of the mobile electronic device using a plurality of sensors. There is an issue where information on a user detected by the mobile electronic device is effectively used. The present disclosure provides an education support system capable of determining a state of an object to be analyzed. Embodiments for implementing the present disclosure will now be described with reference to the accompanying drawings. FIG. 1 is a view illustrating a schematic configuration of an education support system. An education support system 100 illustrated in FIG. 1 includes a plurality of terminal units 40, a fixed electronic device for a manager 102, a tablet for a manager 106, a server (analyzer) 108, and a network 110. The education support system 100 acquires information on actions of students and pupils, causes the server (analyzer) 108 to analyze the acquired information, and outputs the analysis result to the fixed electronic device for a manager 102 or the tablet for a manager 106. Data of each unit is transmitted and received through the network 110.

The terminal units 40 are used by objects actions of which are analyzed. Each of the terminal units 40 includes a mobile device 1 and a tablet 50.

The mobile device 1 is a wearable device. The mobile device 1 is attached to the body of a user. In an example illustrated in FIG. 1, the mobile device 1 is attached to a wrist of a user. Examples of attachment to the body of a user include the mobile device 1 being attached to, for example, a wrist or an arm of a user and the mobile device 1 being held in a pocket of a user.

The mobile device 1 includes a main body 20 and an attachment unit 30. The main body 20 is fixed to the attachment unit 30. The attachment unit 30 is a wristband for attaching the main body 20 to the body of a user. The mobile device 1 is in a state of being attached to the body of a user or is not in a state of being attached to the body of a user. The mobile device 1 collects information on the user while being attached to the body of a user. Examples of the information on a user include information related to a living body of a user, information related to a moving state of a user, and information related to surrounding environment of a user.

The mobile device 1 includes a touch screen display 2 provided to a main surface (front surface) of the main body 20. The touch screen display 2 has a round shape along the peripheral edge of the main surface. The touch screen display 2 has a function of displaying a screen that includes various kinds of information such as characters, figures, and images. The touch screen display 2 also has a function of detecting contact of various kinds of objects such as a finger, a stylus pen, and a pen. The mobile device 1 determines operation of a user related to a screen displayed on the touch screen display 2 based on the contact detected by the touch screen display 2.

The mobile device 1 includes a plurality of sensors. The mobile device 1 controls the drive of the sensors, and causes the sensors to detect various kinds of information. The mobile device 1 performs processing based on detection results detected by the sensors, and collects and stores the detected detection result.

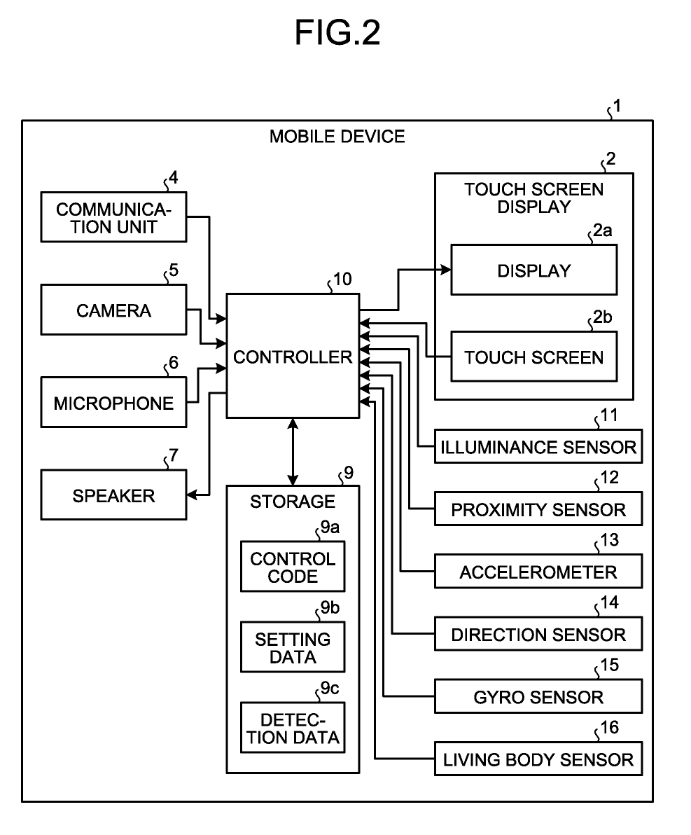

A functional configuration of the mobile device 1 will be described with reference to FIG. 2. FIG. 2 is a block diagram illustrating a functional configuration of the mobile device 1. As illustrated in FIG. 2, the mobile device 1 includes the touch screen display 2, a communication unit 4, a camera 5, a microphone 6, a speaker 7, a storage 9, a controller 10, an illuminance sensor 11, a proximity sensor 12, an accelerometer 13, a direction sensor 14, a gyro sensor 15, and a living body sensor 16.

The touch screen display 2 includes a display 2a and a touch screen 2b overlapping with the display 2a. The display 2a includes a display device such as a liquid crystal display and an organic electro-luminescence (EL) display/inorganic electro-luminescence (EL) display. The display 2a displays characters, figures, images, and the like.

The touch screen 2b detects contact of a finger, a pen/stylus pen, and the like with the touch screen 2b. The touch screen 2b can detect a position at which a plurality of fingers, a pen/stylus pen, and the like contact the touch screen 2b.

A method for detecting the touch screen 2b may be any method such as an electrostatic capacitance method, a resistance film method, a surface acoustic wave method (or an ultrasonic wave method), an infrared method, an electromagnetic induction method, and a load detection method. Hereinafter, for the purpose of simplifying the description, it is assumed that a user contacts the touch screen 2b with his/her fingers for operating the mobile device 1.

The mobile device 1 determines the kind of a gesture based on at least one of the following: contact detected by the touch screen 2b, a position at which the contact is detected, a change in positions at which the contact is detected, an interval at which the contact is detected, and the number of times of detected contact. A gesture is operation performed on the touch screen 2b. Examples of a gesture determined by the mobile device 1 include, but are not limited to, a touch, a long-touch, a release, a swipe, a tap, a double-tap, a long-tap, a drag, a flick, a pinch-in, and a pinch-out.

The mobile device 1 operates based on the gesture determined through the touch screen 2b so as to implement operability intuitive to and easy to use for a user. Operation performed by the mobile device 1 based on the determined gesture may differ depending on a screen displayed on the display 2a. Hereinafter, for the purpose of simplifying the description, “the touch screen 2b detects contact and the mobile device 1 determines the kind of gesture as X based on the detected contact” may be referred to as “a smartphone detects X” or “a controller detects X”.

The communication unit 4 wirelessly communicates. A communication system supported by the communication unit 4 is a wireless communication standard. Examples of the wireless communication standard include communication standards of cellular phones for second-generation (2G), third-generation (3G), fourth-generation (4G), and the like. Examples of the communication standards of cellular phones include long term evolution (LTE), wideband code division multiple access (W-CDMA), CDMA2000, personal digital cellular (PDC), global system for mobile communications (GSM) (registered trademark), and personal handy-phone system (PHS). Examples of the wireless communication standard also include worldwide interoperability for microwave access (WiMAX), IEEE802.11, Bluetooth (registered trademark), infrared data association (IrDA), and near field communication (NFC). The communication unit 4 may support one or a plurality of the communication standards.

The camera 5 converts an imaged image to an electric signal, and outputs the converted electric signal to the controller 10. The microphone 6 converts voice of a user and any other sound to a sound signal, and outputs the converted sound signal to the controller 10. The speaker 7 outputs the sound signal transmitted from the controller 10 as sound.

The storage 9 stores therein a computer code and data. The storage 9 is used as a work area temporarily storing the processing result of the controller 10. The storage 9 may include any non-transitory storage medium such as a semiconductor storage medium and a magnetic storage medium. The storage 9 may include various kinds of storage media. The storage 9 may include a combination of a portable storage medium such as a memory card and an optical disk/a magneto-optical disk with a reading device of a storage medium. The storage 9 may include a storage device used as a temporary storage area such as a random access memory (RAM).

The computer code stored in the storage 9 includes an application executed in the foreground or in the background, and a control code for implementing a basic function of the mobile device 1. For example, the application displays a screen on the display 2a, and causes the controller 10 to execute processing corresponding to a gesture detected through the touch screen 2b. Examples of the control code include an operating system (OS). The application and the control code may be installed in the storage 9 through communication performed by the communication unit 4 or a non-transitory storage medium.

The storage 9 stores therein, for example, a control code 9a, setting data 9b, and detection data 9c. The control code 9a provides a function related to various kinds of control for operating the mobile device 1. The control code 9a controls, for example, the communication unit 4, the microphone 6, and the speaker 7 so as to implement a voice call. Functions provided by the control code 9a include a function of controlling operation of the mobile device 1 depending on a gesture to the touch screen 2b.

The setting data 9b holds various kinds of setting values related to operation of the mobile device 1. The setting data 9b includes, for example, a determination condition for determining that the mobile device 1 is attached to the body of a user. In the embodiments, the determination condition includes conditions such as a determination threshold for determining that the mobile device 1 is attached to the body of a user and a determination time based on the detection result of the living body sensor 16.

The detection data 9c holds information related to a user detected by the sensors. Examples of the sensors include, but are not limited to, the illuminance sensor 11, the proximity sensor 12, the accelerometer 13, the direction sensor 14, the gyro sensor 15, and the living body sensor 16. Examples of the sensors may include a temperature sensor, an ultraviolet sensor, and a global positioning system (GPS) receiver. The detection data 9c stores therein detection information that indicates detection results obtained by the sensors for each of the sensors. Examples of the detection information include items such as a time detected by a sensor and a value detected by a sensor.

The controller 10 includes an arithmetic processor. Examples of the arithmetic processor include, but are not limited to, a central processing unit (CPU), a system-on-a-chip (SoC), a micro control unit (MCU), and a field-programmable gate array (FPGA). The controller 10 may include a plurality of arithmetic processors.

The controller 10 integrally controls operation of the mobile device 1 so as to implement various kinds of functions. Specifically, the controller 10 executes an instruction included in a computer code stored in the storage 9 while referring to data stored in the storage 9 as needed. The controller 10 controls various kinds of devices depending on data and instructions so as to implement various kinds of functions.

The controller 10 executes the control code 9a so as to control the drive of the sensors, and collect and store results detected by the sensors in the detection data 9c. The controller 10 performs processing in accordance with the results detected by the sensors.

The sensors detect an object to be detected depending on a detection cycle, and output the detection results to the controller 10. The controller 10 controls the sensors to start and stop operation. The sensors have a function of changing a detection cycle based on a change request from the controller 10. When changing a detection cycle based on a change request from the controller 10, the sensors detect an object to be detected based on the changed detection cycle.

When executing the control code 9a and, for example, detecting a response of a body based on the result detected by the living body sensor 16, the controller 10 causes the other sensors different from the living body sensor 16 to change the detection cycle. The other sensors are, out of the sensors different from the living body sensor 16, all of or a part of the sensors.

The illuminance sensor 11 detects illuminance of ambient light of the mobile device 1 for each detection cycle. The illuminance is a value of a luminous flux made incident on the unit area of a measurement surface of the illuminance sensor 11. For example, the illuminance sensor 11 is used for adjusting luminance of the display 2a. The proximity sensor 12 detects existence of a neighboring object for each detection cycle without contact. The proximity sensor 12 detects existence of an object based on, for example, a change in a magnetic field or a change in a feedback time of a reflected wave of an ultrasonic wave. The proximity sensor 12 detects, for example, the fact that the touch screen display 2 is brought close to a face. The illuminance sensor 11 and the proximity sensor 12 may be formed in one sensor. The illuminance sensor 11 may be used as a proximity sensor.

The accelerometer 13 detects a direction and magnitude of acceleration acting on the mobile device 1, an angle of an inclination of the mobile device 1, and a direction and magnitude of gravity acceleration for each detection cycle. The direction sensor 14 detects a direction of earth magnetism for each detection cycle. The gyro sensor 15 detects an angle and angular velocity of the mobile device 1 for each detection cycle. The result detected by the accelerometer 13, the direction sensor 14, and the gyro sensor 15 is combined and used for detecting a position, an attitude, and a change in a state of the mobile device 1.

The living body sensor 16 detects a response of a body for each detection cycle. The living body sensor 16 may detect a heart rate as a response of a body, may detect heartbeat as a response of a body, and may detect an electric signal generated from a heart as a response of a body. When detecting a heart rate as a response of a body, the living body sensor 16 includes an infrared sensor and the like. When detecting heartbeat as a response of a body, the living body sensor 16 includes an accelerometer and the like. When detecting an electric signal generated from a heart as a response of a body, the living body sensor 16 includes an electric potential sensor and the like.

In the embodiments, a case where the mobile device 1 detects a heart rate as a response of a body using the living body sensor 16 is described, but the case is not limiting. For example, the mobile device 1 may detect the fact that an object is at a close position as a response of a body. For example, when the mobile device 1 is attached to the body of a user, an acceleration pattern depending on an action of a user acts on the mobile device 1. In this case, the mobile device 1 may detect the acceleration pattern depending on action of a user as a response of a body.

The mobile device 1 can detect whether an object to be analyzed that uses the mobile device 1 walks, runs, sits, raises his/her hand, has a conversation, or the like by acquiring results detected by the sensors. When detecting the fact that an object to be analyzed takes the mobile device 1 off, the mobile device 1 detects an ambient situation so as to detect whether the object to be analyzed sleeps or wakes up.

The tablet 50 is an electronic device by which an object to be analyzed inputs various kinds of information. For example, the tablet 50 is used in, for example, a class, and detects an answer input by an object to be analyzed. In the embodiments, the tablet 50 is used, but any electronic device held by an object to be analyzed can be used including, for example, a smartphone, a feature phone, other mobile phones, and a handset.

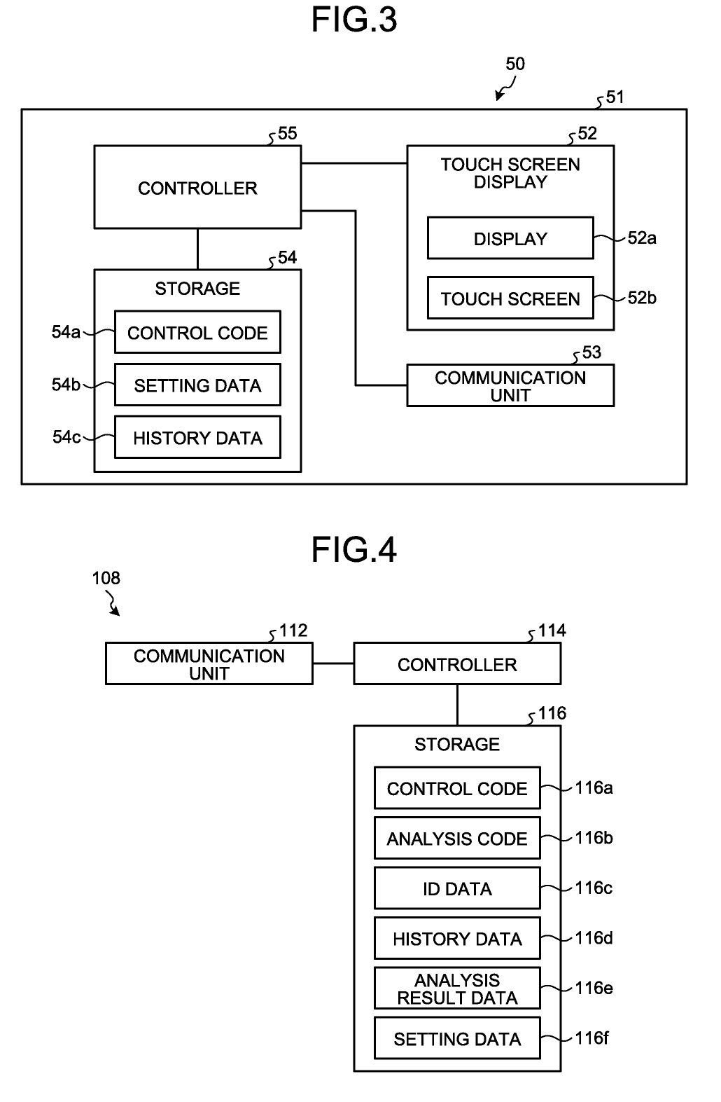

FIG. 3 is a block diagram illustrating a functional configuration of the tablet 50. The tablet 50 includes a housing 51, a touch screen display 52, a communication unit 53, a storage 54, and a controller 55. The housing 51 is a case body of the tablet 50.

The tablet 50 includes the touch screen display 52 provided to a main surface (front surface) of the housing 51. The touch screen display 52 has a rectangular shape along the peripheral edge of the main surface. The touch screen display 52 has a function of displaying a screen that includes various kinds of information such as characters, figures, and images. The touch screen display 52 also has a function of detecting contact of various kinds of objects such as a finger, a stylus, and a pen. The tablet 50 determines operation of a user related to a screen displayed on the touch screen display 52 based on the contact detected by the touch screen display 52.

The touch screen display 52 includes a display 52a and a touch screen 52b overlapping with the display 52a. The display 52a includes a display device such as a liquid crystal display and an organic electro-luminescence (EL) display/inorganic electro-luminescence (EL) display. The display 52a displays characters, figures, images, and the like.

The touch screen 52b detects contact of a finger, a pen/stylus pen, or the like on the touch screen 52b. The touch screen 52b can detect a position at which a plurality of fingers, a pen/stylus pen, or the like contact the touch screen 52b.

A method for detecting the touch screen 52b may be any method such as an electrostatic capacitance method, a resistance film method, a surface acoustic wave method (or an ultrasonic wave method), an infrared method, an electromagnetic induction method, and a load detection method. Hereinafter, for the purpose of simplifying the description, it is assumed that a user contacts the touch screen 52b with his/her fingers in order to operate the tablet 50.

The tablet 50 determines the kind of a gesture based on at least one of the following: contact detected by the touch screen 52b, a position at which the contact is detected, a change in position at which the contact is detected, an interval at which the contact is detected, and the number of times of detected contact. A gesture is operation performed on the touch screen 52b. Examples of a gesture determined by the tablet 50 include, but are not limited to, a touch, a long-touch, a release, a swipe, a tap, a double-tap, a long-tap, a drag, a flick, a pinch-in, and a pinch-out.

The tablet 50 operates based on the gesture determined through the touch screen 52b so as to implement operability intuitive to and easy to use for a user. Operation performed by the tablet 50 based on the determined gesture may differ depending on a screen displayed on the display 52a.

The communication unit 53 wirelessly communicates. A communication system supported by the communication unit 53 is a wireless communication standard. Examples of the wireless communication standard include communication standards of cellular phones for second-generation (2G), third-generation (3G), fourth-generation (4G), and the like. Examples of the communication standards of cellular phones include long term evolution (LTE), wideband code division multiple access (W-CDMA), CDMA52000, personal digital cellular (PDC), global system for mobile communications (GSM) (registered trademark), and personal handy-phone system (PHS). Examples of the wireless communication standard also include worldwide interoperability for microwave access (WiMAX), IEEE8052.11, Bluetooth (registered trademark), infrared data association (IrDA), and near field communication (NFC). The communication unit 53 may support one or a plurality of the communication standards.

The storage 54 stores therein a computer code and data. The storage 54 is used as a work area temporarily storing the processing result of the controller 55. The storage 54 may include any non-transitory storage medium such as a semiconductor storage medium and a magnetic storage medium. The storage 54 may include various kinds of storage media. The storage 54 may include a combination of a portable storage medium such as a memory card and an optical disk/a magneto-optical disk with a reading device of a storage medium. The storage 54 may include a storage device used as a temporary storage area such as a random access memory (RAM).

The computer code stored in the storage 54 includes an application executed in the foreground or in the background, and a control code for implementing a basic function of the tablet 50. For example, the application displays a screen on the display 52a, and causes the controller 55 to execute processing corresponding to a gesture detected through the touch screen 52b. Examples of the control code include an operating system (OS). The application and the control code may be installed in the storage 54 through communication performed by the communication unit 53 or a non-transitory storage medium.

The storage 54 stores therein, for example, a control code 54a, setting data 54b, and history data 54c. The control code 54a provides a function related to various kinds of control for operating the tablet 50. The control code 54a controls, for example, the touch screen display 52 and the communication unit 53 so as to implement execution of various kinds of applications. Functions provided by the control code 54a include a function of controlling operation of the tablet 50 depending on a gesture to the touch screen 52b.

The setting data 54b holds various kinds of setting values related to operation of the tablet 50. Examples of the setting data 54b include data for determining results input in the tablet 50. The history data 54c holds results detected by the application executed in the tablet 50. Specifically, results input in a test and in a class are stored as the history data 54c.

The controller 55 includes an arithmetic processor. Examples of the arithmetic processor include, but are not limited to, a central processing unit (CPU), a system-on-a-chip (SoC), a micro control unit (MCU), and a field-programmable gate array (FPGA). The controller 55 may include a plurality of arithmetic processors.

The controller 55 integrally controls operation of the tablet 50 so as to implement various kinds of functions. Specifically, the controller 55 executes an instruction included in a computer code stored in the storage 54 while referring to data stored in the storage 54 as needed. The controller 55 controls various kinds of devices depending on data and instructions so as to implement various kinds of functions.

The controller 55 executes the control code 54a so as to collect and store input detected on the touch screen 52b in the history data 54c. The controller 55 performs processing depending on the input detected on the touch screen 52b.

The tablet 50 can detect performance of a displayed test, and correctness/error of an answer of a question in a class based on input from an object to be analyzed. The tablet 50 stores results input by an object to be analyzed as the history data 54c.

The fixed electronic device for a manager 102 is a personal computer, and includes input devices such as a keyboard, a mouse, and a touch panel; output devices such as a display unit and a printer; a storage; a controller; and the like. The tablet for a manager 106 basically has the same configuration as that of the tablet 50. The fixed electronic device for a manager 102 and the tablet for a manager 106 acquire the result analyzed by the server (analyzer) 108, and display the acquired result on the display unit.

The server (analyzer) 108 accumulates data transmitted from the terminal units 40, analyzes the accumulated data, considers users of the terminal units 40 as objects to be analyzed, and analyzes actions of the objects. FIG. 4 is a block diagram illustrating a functional configuration of the analyzer. The server (analyzer) 108 includes a communication unit 112, a controller 114, and a storage 116.

The communication unit 112 is provided with wireless communication. A communication system supported by the communication unit 112 is a wireless communication standard. Examples of the wireless communication standard include communication standards of cellular phones for second-generation (2G), third-generation (3G), fourth-generation (4G), and the like. Examples of the communication standards of cellular phones include long term evolution (LTE), wideband code division multiple access (W-CDMA), CDMA52000, personal digital cellular (PDC), global system for mobile communications (GSM) (registered trademark), and personal handy-phone system (PHS). Examples of the wireless communication standard also include worldwide interoperability for microwave access (WiMAX), IEEE8052.11, Bluetooth (registered trademark), infrared data association (IrDA), and near field communication (NFC). The communication unit 112 may support one or a plurality of the communication standards.

The controller 114 includes an arithmetic processor. Examples of the arithmetic processor include, but are not limited to, a central processing unit (CPU), a system-on-a-chip (SoC), a micro control unit (MCU), and a field-programmable gate array (FPGA). The controller 114 may include a plurality of arithmetic processors.

The controller 114 integrally controls operation of the server 108 so as to implement various kinds of functions. Specifically, the controller 114 executes an instruction included in a computer code stored in the storage 116 while referring to data stored in the storage 116 as needed. The controller 114 takes control depending on data and instructions so as to implement various kinds of functions.

The storage 116 stores therein a computer code and data. The storage 116 is used as a work area temporarily storing the processing result of the controller 114. The storage 116 may include any non-transitory storage medium such as a semiconductor storage medium and a magnetic storage medium. The storage 116 may include various kinds of storage media. The storage 116 may include a combination of a portable storage medium such as a memory card and an optical disk/a magneto-optical disk with a reading device of a storage medium. The storage 116 may include a storage device used as a temporary storage area such as a random access memory (RAM).

The computer code stored in the storage 116 includes an application executed in the foreground or in the background, and a control code for implementing a basic function of the server 108. Examples of the control code include an operating system (OS). The application and the control code may be installed in the storage 116 through communication performed by the communication unit 112 or a non-transitory storage medium.

The storage 116 stores therein, for example, a control code 116a, an analysis code 116b, identification (ID) data 116c, history data 116d, analysis result data 116e, and setting data 116f. The control code 116a provides a function related to various kinds of control for operating the server 108. The control code 116a has a function of controlling communication with other devices. Specifically, the control code 116a communicates with other devices, and has functions of acquiring data from the respective devices and of transmitting the data.

The analysis code 116b executes analysis based on information acquired from the terminal units 40. The analysis code 116b calculates an activity amount based on, for example, information on an action acquired by the mobile device 1, which will be described later.

The ID data 116c includes identification information on objects to be analyzed that have the terminal units 40. The ID data 116c associates objects to be analyzed with identification information on the mobile device 1 and identification information on the tablet 50. The ID data 116c also includes information on an activity schedule (event) of objects to be analyzed and information on an activity target. The activity schedule means events scheduled to be performed by objects to be analyzed, for example, wakeup, preparation for departure, going to school, classes, a break time, school lunch, club activities, culture lessons, leaving school, homework, preparation for sleeping, and sleeping. The activity target includes a time target for executing each activity schedule, the number of times, a target of an action, and the like.

The history data 116d stores various kinds of data transmitted from the mobile device 1 and the tablet 50. The analysis result data 116e stores the result processed by the analysis code 116b. The setting data 116f includes a condition at the time of executing analysis, a condition of stored data, frame data at the time of creating a screen, and the like.

The setting data 116f holds various kinds of setting values related to operation of the server 108. Examples of the setting data 116f include data for determining the results input in the tablet 50. The history data 116d holds the results detected by the application executed in the tablet 50. Specifically, the results input in a test and in a class are stored as the history data 116d.

The network 110 is a communication network that executes communication of the respective devices. The network 110 may be a communication network that executes communication through a public communication line network, but may be a communication network in a facility provided in a certain facility.

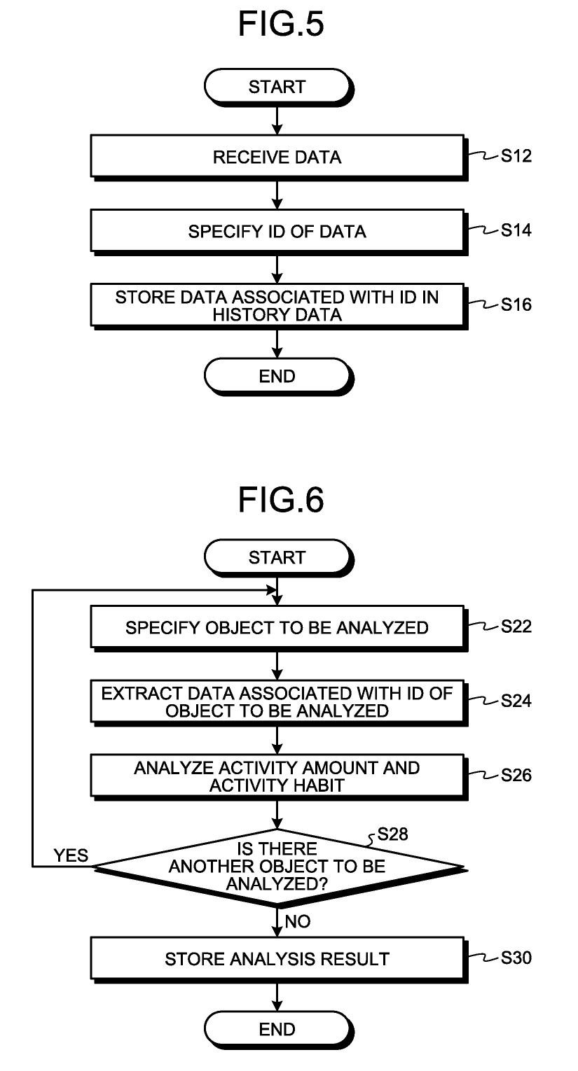

FIG. 5 is a flowchart illustrating an example of operation of the analyzer. The analyzer 108 performs processing with the control code 116a stored in the storage 116 so as to implement processing illustrated in FIG. 5. The analyzer 108 receives data transmitted from the terminal units 40 (Step S12). The analyzer 108 receives data transmitted from at least one of the mobile device 1 and the tablet 50 in each of the terminal units 40.

When receiving data, the analyzer 108 specifies an identification (ID) of the received data (Step S14). The analyzer 108 specifies, based on the received data, an object that uses the terminal unit 40 transmitting the data. The analyzer 108 stores data associated with the ID in the history data 116d (Step S16). The analyzer 108 classifies the received data for each object (ID) and accumulates the data for each object in the history data 116d.

FIG. 6 is a flowchart illustrating an example of operation of the analyzer. The analyzer 108 performs processing with the analysis code 116b stored in the storage 116 so as to implement processing illustrated in FIG. 6. The analyzer 108 specifies an object to be analyzed (Step S22). Specifically, the analyzer 108 specifies, out of the objects to be analyzed, one object.

Subsequently, the analyzer 108 extracts data associated with an ID of the object to be analyzed (Step S24). The analyzer 108 analyzes an activity amount and an activity habit based on the extracted data (Step S26). The analyzer 108 specifies, based on an action of the extracted object to be analyzed and time data of the action, an action of the object to be analyzed for each activity schedule and calculates an activity amount and an activity habit for each activity schedule. Examples of the activity schedule include classes, a break time, a time for going to/leaving school, a club activity time, a sleeping time, and a dressing time. The server 108 further analyzes the analysis result for each activity schedule and determines whether attention needs to be paid to the object to be analyzed.

After analyzing an activity amount and an activity habit of an object to be analyzed, the analyzer 108 determines whether there is another object to be analyzed (Step S28). When the analyzer 108 determines that there is another object to be analyzed (Yes at Step S28), the process goes back to Step S22 and the analyzer 108 executes analysis on the next object to be analyzed. If not (No at Step S28), the analyzer 108 stores an analysis result (Step S30). The analyzer 108 executes the above-mentioned processing, and analyzes an action of an object to be analyzed based on the result detected by the mobile device 1 and the tablet 50.

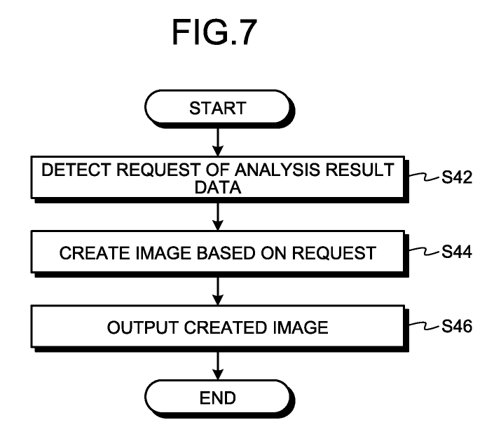

FIG. 7 is a flowchart illustrating an example of operation of the analyzer 108. When receiving an acquisition request of the analysis result from the fixed electronic device for a manager 102 or the tablet for a manager 106, the analyzer 108 executes processing in FIG. 7.

When detecting a request of analysis result data (Step S42), the analyzer 108 creates an image based on the request (Step S44). The analyzer 108 outputs the created image to the fixed electronic device for a manager 102 or the tablet for a manager 106 (Step S46). In the embodiments, the analyzer 108 creates an image, but may transmit target data to the fixed electronic device for a manager 102 or the tablet for a manager 106, and the fixed electronic device for a manager 102 or the tablet for a manager 106 may create an image.

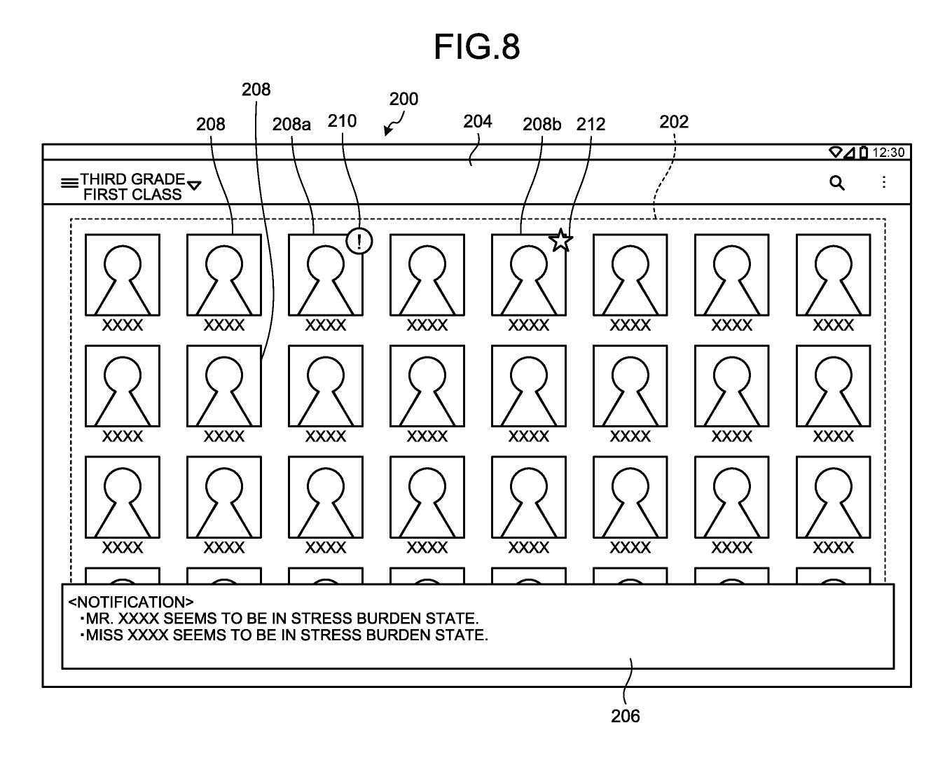

The following describes an example of how to display an analysis result with reference to FIGS. 8 to 13. FIGS. 8 to 13 are examples of the screen displayed on the tablet for a manager 106. FIG. 8 is a screen displaying a list of objects to be analyzed. A screen 200 illustrated in FIG. 8 includes an object list field 202, a toolbar field 204, and a popup display field 206. In the object list field 202, objects to be analyzed are displayed as a plurality of icons 208, 208a, and 208b. The icons 208, 208a, and 208b display pictures or illustrations and names of objects to be analyzed. In the object list field 202, out of the icons 208, 208a, and 208b, marks 210 and 212 are displayed on the objects to which attention needs to be paid as a result of analysis. The mark 210 is displayed when attention is determined to be paid because there is an item that is evaluated to be lower than average. The mark 212 is displayed when attention is determined to be paid because there is an item that is evaluated to be higher than average. The mark 210 is displayed overlapping with the icon 208a. The analyzer 108 determines that an object to be analyzed corresponding to the icon 208a is in a stress burden state. The mark 212 is displayed overlapping with the icon 208b. The analyzer 108 determines that an object to be analyzed corresponding to the icon 208b is in a good activity state. The popup display field 206 describes objects to which attention needs to be paid and the determination result of the state of the objects in writing.

As described above, the education support system 100 analyzes an object to be analyzed based on information acquired by the mobile device 1 and the tablet 50, and displays the determination result as the screen 200 so as to find, in a certain group, for example, in a list of objects to be analyzed in a class, an object to be analyzed to which attention needs to be paid.

When the analyzer 108 has reference data, and an activity amount of an object to be analyzed is smaller with respect to the reference data, it is preferable that the analyzer 108 cause the fixed electronic device for a manager 102, the tablet for a manager 106 or the like to display warning information. The reference data may be preliminarily stored in the storage 116. The reference data may be an average value of the analysis result data 116e of objects to be analyzed or data based on the average value. The reference data may be an average value of the analysis result data 116e of one object to be analyzed, which is acquired for a specific period, or data based on the average value. As described above, the warning information may be, for example, the mark 210 in FIG. 8, or a sentence described in the popup display field 206.

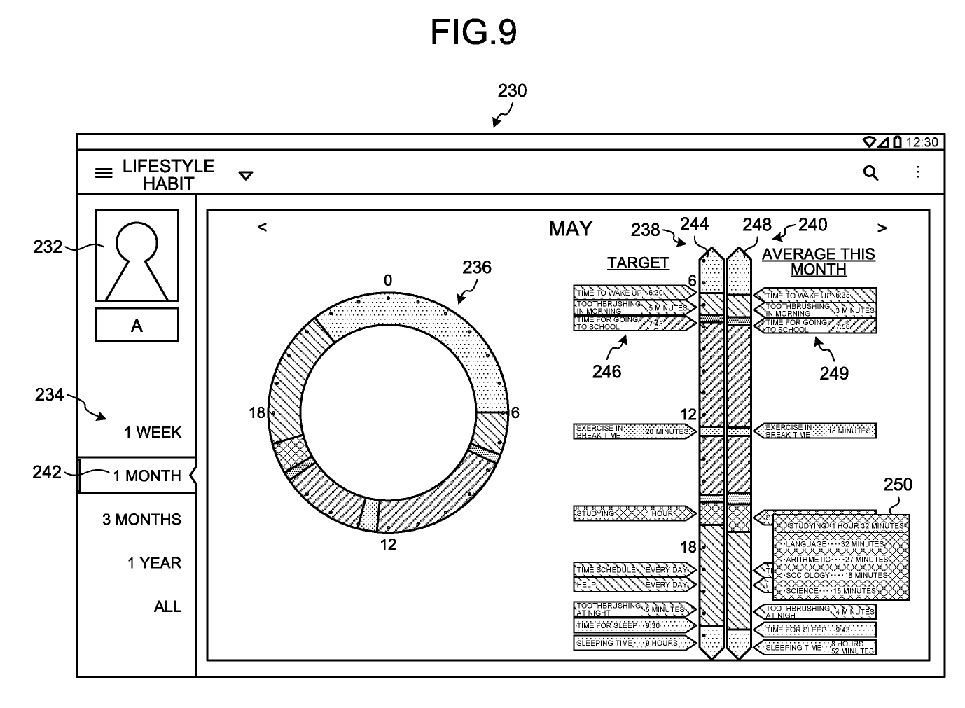

FIG. 9 is a screen illustrating an analysis result of a lifestyle habit of an object to be analyzed. For example, when one of the icons 208 is selected at the time of displaying the screen 200 illustrated in FIG. 8, the tablet for a manager 106 acquires information on an object to be analyzed corresponding to the selected icon 208, and displays a screen 230 illustrated in FIG. 9. The screen 230 includes an object to be analyzed display field 232, an analysis unit display field 234, an analysis graph display field 236, a target lifestyle habit display field 238, and an average lifestyle habit display field 240. The object to be analyzed display field 232 includes an icon of an object to be analyzed and display of a name.

The analysis unit display field 234 indicates a target period of data used for the displayed analysis result. In the analysis unit display field 234, five periods: “one week”, “one month”, “three months”, “one year”, and “all” are selectable. In FIG. 9, “one month” is selected, and a mark 242 different from those of other items is assigned to a selected item.

The analysis graph display field 236 illustrates a sleeping time, a time at home, a time at school, a time for lunch break, and a studying time in a graph indicating a day as a peripheral circle. The displayed classification is not limited to this example, but can be changed based on an activity schedule.

The target lifestyle habit display field 238 is displayed side by side with the average lifestyle habit display field 240. The target lifestyle habit display field 238 displays a predetermined target of each activity in a time period except for a part of the sleeping time along an axis extending longitudinally. The target lifestyle habit display field 238 includes a time schedule 244 displaying a time schedule of each activity schedule and a popup 246 displaying an event of each activity schedule with respect to the time schedule 244 along one axis. The time schedule 244 and the popup 246 are created based on a predetermined schedule. The average lifestyle habit display field 240 displays average data in a target period of analysis (for example, a month) of each activity in a time period except for a part of the sleeping time along the axis extending longitudinally. The average lifestyle habit display field 240 includes a time schedule 248 displaying a time schedule of each activity schedule and a popup 249 displaying an event for each activity schedule with respect to the time schedule 248 along one axis. The time schedule 248 and the popup 249 are created based on the result obtained by analyzing data acquired by the mobile device 1 and the tablet 50 of an object to be analyzed. The average lifestyle habit display field 240 also includes a popup display field 250. The popup display field 250 displays, out of a plurality of popups 249, detailed information on specific activity as one popup (for example, a breakdown of a studying time for each learning subject).

As described above, the education support system 100 analyzes an object to be analyzed based on information acquired by the mobile device 1 and the tablet 50, and displays the determination result as the screen 230 so as to recognize an activity state of the object to be analyzed. The education support system 100 displays both a target and an achievement on the screen 230, so that a manager can easily determine the state.

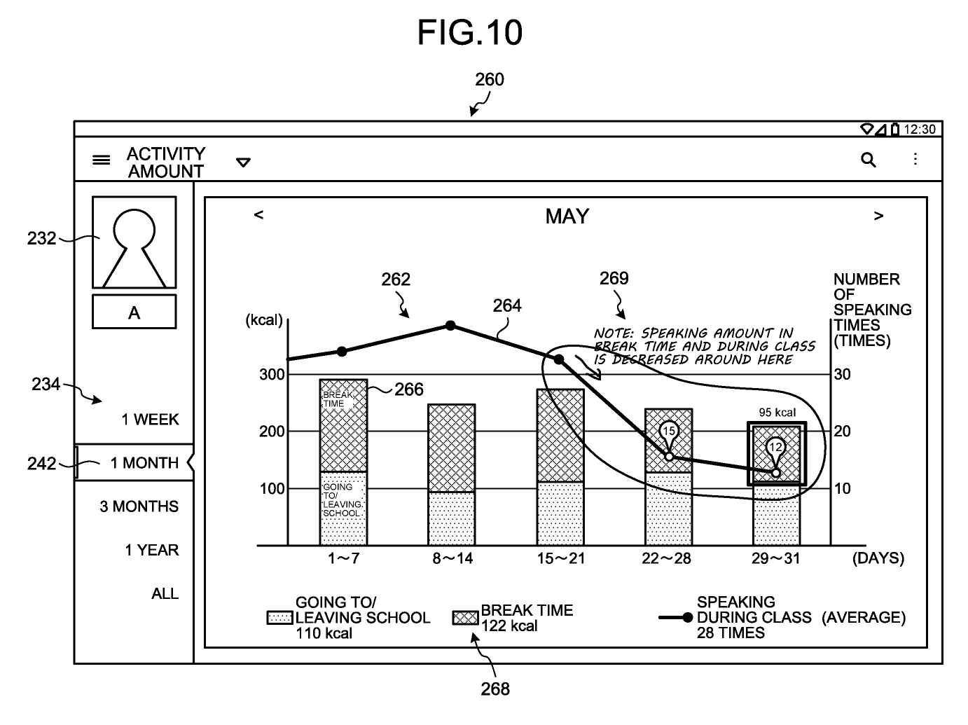

FIG. 10 is a screen illustrating an analysis result of an analysis amount of an object to be analyzed. For example, when one of the icons 208 is selected and an activity amount is selected as an analysis item at the time of displaying the screen 200 illustrated in FIG. 8, the tablet for a manager 106 acquires information on an object to be analyzed corresponding to the selected icon 208, and displays a screen 260 illustrated in FIG. 10. The screen 260 includes the object to be analyzed display field 232, the analysis unit display field 234, and an analysis graph display field 262. The object to be analyzed display field 232 and the analysis unit display field 234 have the same items as those in the screen 230 illustrated in FIG. 9.

The analysis graph display field 262 illustrates a graph of an average of an activity amount for each week in a month. As the activity amount, calorie consumption at the time of going to/leaving school, calorie consumption for a break time, and the number of speaking times are calculated. The calorie consumption at the time of going to/leaving school and the calorie consumption for a break time are calculated based on detection results of movement of an object to be analyzed, which is detected by the mobile device 1. The number of speaking times is calculated based on sound data or the number of times where an object to be analyzed raises his/her hand during a class. The analysis graph display field 262 includes a line graph 264 and a bar graph 266. The line graph 264 indicates an average value of the number of speaking times. The bar graph 266 indicates a sum value of calorie consumption. The analysis graph display field 262 displays the average value of the calorie consumption at the time of going to/leaving school, the calorie consumption of a break time, and the number of speaking times during a class in an explanatory note display field 268. The screen 260 also includes information input in a graph by a manager. An image 269 is a result where a manager inputs to the screen 260 in the tablet for a manager 106.

As described above, the education support system 100 detects an activity amount, detects an activity amount for each activity schedule of an object to be analyzed, and performs analysis so as to recognize a state of the object to be analyzed with great accuracy. The education support system 100 recognizes the state during a class from the number of speaking times, and the state of a break time and going to/leaving school from calorie consumption so as to perform analysis in response to each activity schedule. In this manner, the education support system 100 can perform more appropriate analysis.

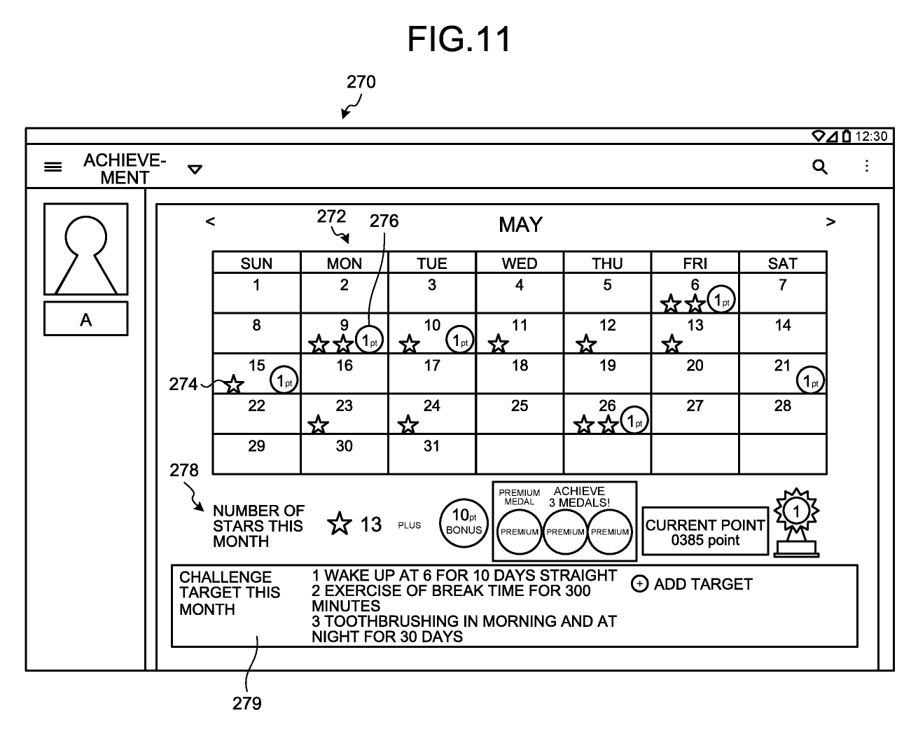

FIG. 11 is a screen illustrating an analysis result of target achievement of an object to be analyzed. For example, when one of the icons 208 is selected and a target achievement is selected as an analysis item at the time of displaying the screen 200 illustrated in FIG. 8, the tablet for a manager 106 acquires information on an object to be analyzed corresponding to the selected icon 208, and displays a screen 270 illustrated in FIG. 11. It is preferable that an object to be analyzed can view the screen 270.

The screen 270 includes a calendar 272, an achievement result display field 278, and a target display field 279. Displayed on the calendar 272 are a date, a mark 274 indicating that a target is achieved in days, and a mark 276 indicating a day when a point is acquired in days. The achievement result display field 278 displays the number of times where a target is achieved in a period displayed on the calendar 272 or the number of the acquired points that are set to the achievement of the target. The target display field 279 displays a set target. The analyzer 108 can determine a state of achieving a target based on the target set for each object to be analyzed and information on history of the detected activity.

As described above, the education support system 100 detects activity with respect to an activity schedule, detects a state of achieving a predetermined target, and displays the state so as to recognize an action of an object to be analyzed more precisely. The screen 270 can be viewed by an object to be analyzed so as to increase an incentive to achieve a target and improve a lifestyle habit and an activity state.

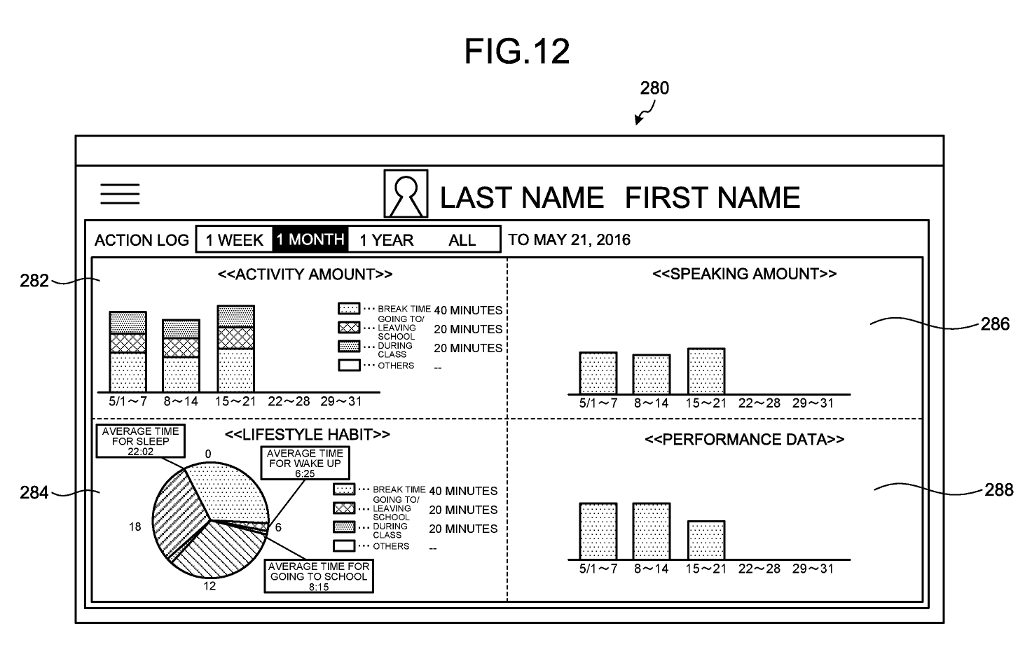

FIG. 12 is a screen indicating an analysis result of an object to be analyzed. A screen 280 illustrated in FIG. 12 displays a plurality of analysis results. The screen 280 includes an activity amount display field 282, a lifestyle habit display field 284, a speaking amount display field 286, and a performance data display field 288. The activity amount display field 282 calculates an action amount for each activity schedule (calorie consumption), and displays the result in a bar graph. The lifestyle habit display field 284 displays a time for executing an activity schedule in a day and a time related to each activity schedule. The speaking amount display field 286 displays a detected speaking amount. The performance data display field 288 displays acquired performance data. The performance data is calculated based on detection of information input in the tablet 50 or results of a test input in at least one of the fixed electronic device for a manager 102 and the tablet for a manager 106.

As described above, the education support system 100 displays a plurality of pieces of information on an object to be analyzed, so that a manager can preferably determine each item. Including data other than an activity amount acquired by, for example, the tablet 50 enables a manager to recognize a state of an object to be analyzed more appropriately.

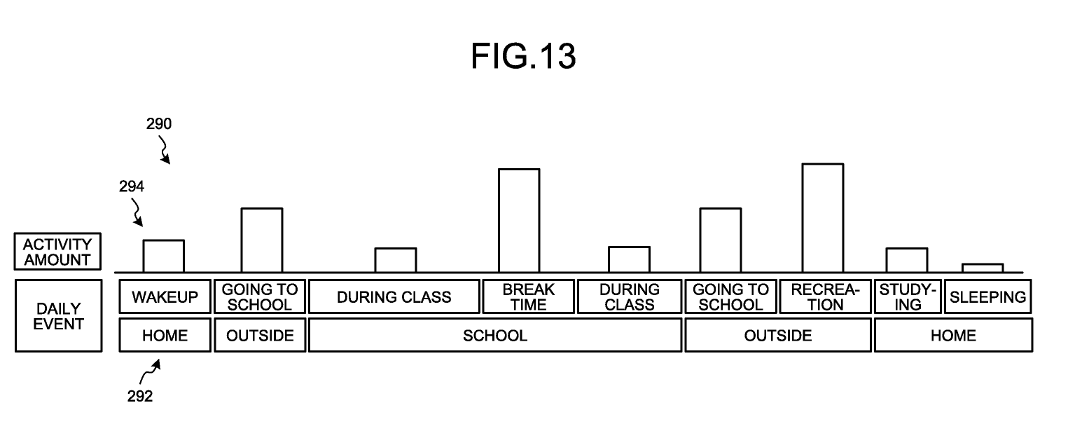

FIG. 13 is a screen indicating an analysis result of an object to be analyzed. A screen 290 illustrated in FIG. 13 displays an activity amount for each action schedule in a bar graph. The screen 290 includes an action schedule display field 292 and an activity amount display field 294. The action schedule display field 292 displays an activity schedule set as a daily event in chronological order. The activity amount display field 294 displays an activity amount for each activity schedule in the action schedule display field 292. Separate actions for each action schedule may be detected as the activity amount. As described above, the education support system 100 may display a daily activity amount for each activity schedule.

The education support system 100 may determine openness, neuroticism, extraversion, cooperativeness, industriousness, and the like of the object to be analyzed, based on the result of each activity schedule (event) and the activity amount, and display the determination result.

Characteristic embodiments have been described for completely and clearly disclosing a technique according to appended claims. However, the appended claims are not limited to the embodiments, and should be formed so as to implement all of the modifications and alternative configurations that could have been created by the skilled person in the technical field without departing from the scope of basic matters described in the specification.

What is claimed is:

1. An education support system comprising:
a mobile device that is attached to an object and is configured to detect an action of the object; and
an analyzer that has information on an activity schedule including a learning schedule of the object, the analyzer configured to calculate an activity amount for each activity schedule based on an action of the object detected by the mobile device and determine a state of the object based on the activity amount for each activity schedule.

2. The education support system according to claim 1, further comprising:
an electronic device configured to acquire an analysis result from the analyzer, wherein
the electronic device is configured to display the analysis result.

3. The education support system according to claim 2, wherein the analyzer is configured to separately analyze an activity amount for each activity schedule of the object.

4. The education support system according to claim 3, wherein the analyzer has reference data, and is configured to cause, when an activity amount of the object is smaller with respect to the reference data, the electronic device to display warning information.

5. The education support system according to claim 1, wherein the activity schedule includes a class, a break time, and a time for going to/leaving school.
